(19) United States
(12) Patent Application Publication
(10) Pub. No.: US 2026/0197908 A1
(43) Pub. Date: Jul. 9, 2026

(54) ELECTRIC ENERGY STORAGE DEVICE

(71) Applicant: TEXEL Energy AB, GÖTEBORG (SE)

(72) Inventor: Lars Jacobsson, Göteborg (SE)

(21) Appl. No.: 19/132,779

(22) PCT Filed: Nov. 24, 2023
(86) PCT No.: PCT/EP2023/083077

§ 371 Date: May 23, 2025

(30) Foreign Application Priority Data
Nov. 25, 2022 (SE) 2251375-8

(51) Int. Cl. H05B 6/10; B01J 8/02; C01B 3/0031; H05B 6/44

(52) U.S. Cl. CPC H05B 6/108; B01J 8/0278; B01J 8/0285; C01B 3/0031; H05B 6/44; B01J 2208/00168; B01J 2208/0038; B01J 2208/00433

(57) ABSTRACT

Device (1) for storing electric energy, comprising a heat reaction chamber (3), an energy storage (4), and a heat exchanger (12) adapted to be heated by the heat reaction chamber (3), where the heat reaction chamber (3) comprises a high enthalpy hydride material mixed with a susceptor material and a first metal coil (5), where the energy storage (4) comprises a low enthalpy hydride material mixed with a susceptor material and a second metal coil (6), and where a valve (7) is arranged between the heat reaction chamber (3) and the energy storage (4), where the device comprises an electromagnetic source (8) connected to the first metal coil (5) and adapted to output an alternating electromagnetic field to the first metal coil (5), where the first metal coil (5) acting as an antenna is adapted to transmit the electromagnetic field to the susceptor material in the heat reaction chamber (3), such that the high enthalpy hydride material is heated to release a hydrogen gas.

### TECHNICAL FIELD

The present invention relates to a device and system for storing renewable electric energy. The storage device comprises a low enthalpy metal hydride and the energy is stored in chemical bonds in the low enthalpy metal hydride and is converted to thermal energy when the hydrogen H₂ gas is released from the low enthalpy metal hydride to react a high enthalpy metal hydride.

### BACKGROUND ART

As renewable energy is increasing at a rapid pace, more systems for generating electricity from wind or solar are developed and installed. Wind power plants generate electric energy through a rotating generator. Some solar power systems use photovoltaic cells to produce electricity directly, which may be converted to e.g. an appropriate alternating current for a grid system. Other solar power systems use mirrors to concentrate the radiation to a focus point in which a heat driven generator is positioned. The heat driven generator may be a Stirling engine, or in larger power plants, a steam turbine.

A disadvantage with the energy produced through renewable technologies is that the produced energy is instantaneous and that it is very expensive to store the energy in rechargeable battery cells. The cost for such a system is thus very high, and the system is often combined with a fuel-based generator in order to later produce electricity when the wind is not blowing or the sun is not shining.

It is also known to store energy as heat in different heat storing devices that may use e.g. melted material or phase-change material. The energy may be stored at low temperature or high temperature. Low temperature storage may e.g. include large water tanks that store hot water for heating purposes from summer to winter in isolated containers. High temperature storage may e.g. comprise salt compounds, sulphur, aluminium or graphite. With a high temperature storage, the heat may be used e.g. to power a thermal cycle such as a Stirling engine where both heat and electricity can be obtained.

DE 102014002761 A1 discloses an energy system adapted to store renewable energy from e.g. solar panels or wind turbines. The energy system comprises a thermochemical storage and can produce electricity through a sterling motor and a generator. The system can also deliver heat for heating purposes. The described system uses magnesium hydride to store and release energy.

These system may work in some cases, but there is still room for improvements.

### DISCLOSURE OF INVENTION

An object of the invention is therefore to provide a device for storing electric energy. A further object of the invention is to provide a system for storing electric energy, and for producing heat in a controlled manner from the stored energy. A further object of the invention is to provide a method for storing electric energy.

The solution to the problem according to the invention is described in the appended claims for a device, a system and a method. The other claims contain advantageous embodiments and further developments of the device, the system and the method.

In a device for storing electric energy, comprising a heat reaction chamber, an energy storage, and a heat exchanger adapted to be heated by the heat reaction chamber, where the heat reaction chamber comprises a first hydride material mixed with a susceptor material and a first metal coil, where the energy storage comprises a second hydride material mixed with a susceptor material and a second metal coil, and where a valve is arranged between the heat reaction chamber and the energy storage, the object of the invention is achieved in that the device comprises an alternating current source connected to the first metal coil and adapted to output an alternating current to the first metal coil, where the first metal coil acting as an antenna is adapted to generate and transmit the electromagnetic field to the susceptor material in the heat reaction chamber, such that the first hydride material is heated to release a hydrogen gas.

The first hydride material is a high enthalpy hydride material and the second hydride material is a low enthalpy hydride material. In other words, first and second hydride materials are different types of materials.

By this first embodiment of the energy storing device according to the invention, an electric energy storage device that is adapted to store renewable electric energy is provided. The renewable electric energy is used to heat a hydrogenated first hydride material positioned in the heat reaction chamber to a temperature between 750 to 900° C. The heating of the first hydride material is performed by transmitting an electromagnetic field via the first metal coil to the susceptor material, which will absorb the energy with a concomitant increase in temperature. The first metal coil will acts as a generator and transmitter antenna for the electromagnetic field. The susceptor material is heated and will in turn heat the first hydride material which will release a hydrogen H₂ gas. By controlling the amount of radiated electromagnetic field, the amount of released hydrogen gas can be controlled. The pipe of the first metal coil and the second metal coil may be hollow to allow for a flow of heat transfer liquid through the pipes of the coils.

The heating of the susceptor material and first hydride material with the electromagnetic field in the heat reaction chamber will cause a release of hydrogen gas from the first hydride material in a endothermic reaction, i.e. a reaction that absorbs heat from the surroundings.

The high enthalpy hydride material has a high chemical reaction enthalpy, and the low enthalpy hydride material has a low chemical reaction enthalpy.

The first metal coil is configured to generate an alternating electromagnetic field from the alternating current flowing in the first metal coil. The alternating electromagnetic field heats the susceptor material by generating an induced current in the susceptor material, also referred to as eddy current. The eddy currents flow through the resistance of the susceptor material and heats the susceptor material by Joule heating and/or magnetic hysteresis losses.

In some example embodiments, the alternating current source may be deemed to represent an electromagnetic source adapted to output an alternating electromagnetic field to the first metal coil, wherein the first metal coil transmits the electromagnetic field to the susceptor material in the heat reaction chamber.

The electromagnetic field radiated by the first metal coil generates the desired heat that gives the hydrogenated high enthalpy hydride material the desired temperature for hydrogen release at a desired pressure, where the valve is actuated to allow a flow of hydrogen gas to the low enthalpy hydride material in the energy storage. By controlling the amount of electromagnetic field generated and transmitted by the first metal coil, the amount of released hydrogen gas from the high enthalpy hydride material and the pressure in the heat reaction chamber is controlled.

The pressure of the gas that is released from the high enthalpy hydride material depends partly on the temperature in the heat reaction chamber, but may be from 5 bars and up to 30-40 bars. This pressure is enough for the gas to pass into the energy storage through a valve. In the energy storage, the gas is absorbed by the low enthalpy hydride material. The gas is thus stored as a hydride and when the gas is absorbed, the pressure in the energy storage is a low pressure of around 1 bar. The energy storage vessel is closed off from the atmosphere.

A temperature-controlled heat transfer liquid may be circulated through the second metal coil to prevent the temperature in the energy storage from rising too much due to the exothermic reaction between the hydrogen gas and the low enthalpy hydride material. The temperature in the energy storage could e.g. be held at a temperature of between 30-80 degrees Celsius, and should preferably be restricted to a maximum of 150 degrees Celsius. By controlling the temperature in the energy storage, the speed of the hydrogen gas absorption in the low enthalpy hydride material can be controlled. As the hydrogen gas absorption continues, the temperature-controlled heat transfer liquid is circulated inside the second metal coil to remove the excess heat from the energy storage and to maintain the desired temperature. By controlling the circulation temperature of the heat transfer liquid circulated through the hollow second metal coil, the absorption time of the hydrogen gas can be controlled.

It is also be possible to circulate the heat transfer liquid through a phase change material in which the excess temperature can be stored. This energy can be used to heat the low enthalpy material for hydrogen release back to the high enthalpy material.

When the amount of electric energy that is to be stored has been used to heat the heat reaction chamber, or when the high enthalpy hydride material is depleted of hydrogen, the heating process is stopped. The temperature in the heat reaction chamber will slowly decrease, depending on the amount of insulation material used to insulate the heat reaction chamber. In some systems, the energy transfer process is used regularly, e.g. every night. In this case, it is of advantage to hold the temperature in the heat reaction chamber at a constant high temperature. At the same time, the temperature in the energy storage will decrease to a temperature around room or ambient temperature, e.g. around 15-25 degrees Celsius. The temperature in the energy storage may be controlled by circulating the heat transfer liquid through the second metal coil. The pressure in the energy storage will decrease to a low pressure of around 1 bar when all the hydrogen gas is absorbed.

After a predefined time, or when heating energy is required, the recovery of energy is started. In order to release the hydrogen gas from the low enthalpy hydride material, the energy storage is heated somewhat. Depending on the required energy and thus the required gas flow from the energy storage, the low enthalpy hydride material is heated to a temperature above the ambient temperature. A suitable temperature may be between 30-150 degrees Celsius. The used temperature is dependent on the low enthalpy material.

The energy storage may be heated by circulating a heated heat transfer liquid through the hollow second coil. This type of heating is suitable for lower gas output. To achieve an instant heat release from the high enthalpy hydride material contained in the heat reaction chamber, i.e. to provide a quick hydrogen gas release from the energy storage, an electromagnetic field can be generated and transmitted by the second coil inside the energy storage. The electromagnetic field will heat the susceptor material in the energy storage such that the low enthalpy hydride material is heated and releases the hydrogen gas. The temperature in the energy storage is controlled by precise pulsation of the electromagnetic field to reach the desired temperature needed to release hydrogen at the required rate and pressure needed for the desired energy output. The flow of hydrogen gas and the reaction of hydrogen gas with the high enthalpy hydride material in the heat reaction chamber causes an exothermic release of energy, thus delivering heat to a heat exchanger that heats a fluid that can be used e.g. for residential heating.

The heat exchanger is in one example the first coil through which a fluid is circulated. In other words, in one example embodiment, the first metal coil of the heat reaction chamber is used also for extracting heat, provided from the exothermic release of energy, from the heat reaction chamber to an external user. It is also possible to provide the heat reaction chamber with other types of fluid tubes that act as a heat exchanger, e.g. a plurality of straight tubes interposed in the high enthalpy hydride material. The tubes may e.g. be arranged between the first coil and the outer side of the heat reaction chamber, and may be used as a heat exchanger together with the first coil in parallel, or separately.

Consequently, the present disclosure relates to a device for storing electric energy in form of thermal energy. This is sometimes referred to as a thermal energy storage (TES). The present disclosure describes a thermo-chemical heat storage (TCS) that involves some kind of reversible exothermic/endothermic chemical reaction of the heat storage media.

### BRIEF DESCRIPTION OF DRAWINGS

The invention will be described in greater detail in the following, with reference to the embodiments that are shown in the attached drawings, in which

FIG. 1 shows an example of a device for storing electric energy according to the invention, and

FIG. 2 shows an example of a system for storing renewable electric energy according to the invention.

### MODES FOR CARRYING OUT THE INVENTION

The embodiments of the invention with further developments described in the following are to be regarded only as examples and are in no way to limit the scope of the protection provided by the patent claims.

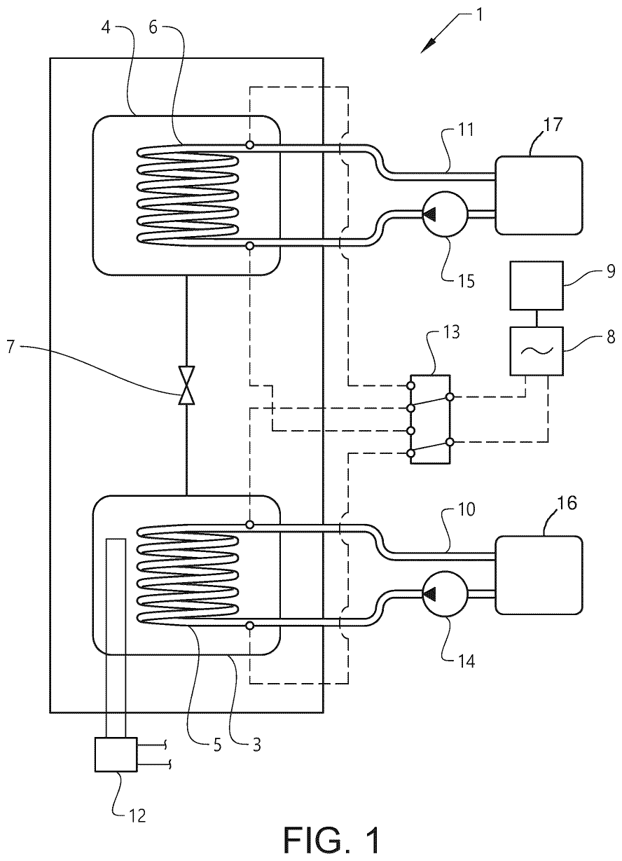

FIG. 1 shows an example of a device 1 for storing electric energy according to the invention. The device 1 is adapted to convert heat to storable energy and to convert the storable energy back to heat. The device is provided with a heat reaction chamber 3 that is heated with an electromagnetic field such that a hydrogen gas H₂ is released from the heat reaction chamber, and an energy storage 4 where the hydrogen gas is stored. Energy is recovered by returning hydrogen gas back to the heat reaction chamber, where the hydrogen gas reacts with the high enthalpy hydride material in an exothermic reaction, and where the heat is transferred to the surroundings through a heat exchanger. By the energy storage device, renewable electric energy can be stored in an efficient way. The renewable electric energy is used to heat a hydrogenated high enthalpy hydride material positioned in the heat reaction chamber to a temperature between 750 to 900° C. The heating of the high enthalpy hydride material is performed by transmitting an electromagnetic field via a first metal coil 5 in the heat reaction chamber to the susceptor material, which will absorb the energy and will heat up. The first metal coil will act as a generator and transmitter antenna for the electromagnetic field. The susceptor material will be heated and will in turn heat the high enthalpy hydride material that will release a hydrogen gas. By controlling the amount of radiated electromagnetic field, the amount of released hydrogen gas can be controlled.

The heat reaction chamber 3 comprises a high enthalpy hydride material mixed with a susceptor material. Both the high enthalpy hydride material and the susceptor material may be a powder or a pressed powder. The high enthalpy hydride material and/or the susceptor material may alternatively be formed as pellets, balls or spherical objects.

In the shown example, the high enthalpy hydride material is Ca₃Al₂Si₂. Other high enthalpy hydride materials that may be used in the heat reaction chamber includes materials comprising a metal such as e.g. sodium (Na), magnesium (Mg), titanium (Ti), calcium (Ca), aluminium (Al), iron (Fe), strontium (Sr) or barium (Ba), depending on e.g. the highest allowed temperature to be used. Since this material is a nonconductive hydride, it is mixed with a susceptor material comprising Cobalt (Co), Nickel (Ni), Iron (Fe), Silicon Carbide (SiC) or Carbon (C) or a combination thereof. Such a material will act as a susceptor material that can be heated with an electromagnetic field. The susceptor material will heat the high enthalpy hydride material such that the high enthalpy hydride material will release hydrogen upon satisfying the binding energy in the chemical bonds between the hydrogen gas and the high enthalpy hydride material.

A first metal coil 5 is embedded in the mixture of high enthalpy hydride material and susceptor material. The metal coil is used as a transmitter antenna generating and transmitting an electromagnetic field in the heat reaction chamber. An alternating current is fed from an current source 8, controlled by an electronic control unit (ECU) 9, to the first metal coil 5.

In some example embodiments, the energy storage device may include an electrical switch 13 that is connected to the alternating current source 8 and to the first metal coil 5, wherein the electrical switch 13 controls connection and disconnection of the alternating current source 8 with the first metal coil 5. Operation of the electrical switch 13 may be controlled by the ECU 9.

Input to the current source 8 is the electric energy that is to be stored in the energy storage device. The electromagnetic field will heat the susceptor material in the heat reaction chamber and the susceptor material will in turn heat the high enthalpy hydride material.

In some example embodiments, the alternating current source 8 may for example be the electric grid having a utility frequency of about 50-60 Hz. However, in some implementations, this frequency is too low for accomplishing the required heating effect within the heat reaction chamber 3. In such cases, the alternating current source 8 may be an inverter or a frequency converter, and the alternating current provided by the AC-source 8 may have a frequency in the kHz-range.

The electrical power supplied from the alternating current source 8 to the first metal coil 5 may be selected suitable for each specific implementation, and may for example be within 5-250 KW, specifically within 50-150 KW.

The first metal coil 5 is in the shown example a hollow coil comprised in a first fluid circuit 10. A liquid can be circulated through the first fluid circuit by a first pump 14 and can in one example be used to stabilize the temperature in the heat reaction chamber during the heating of the heat reaction chamber. The temperature in the heat reaction chamber is controlled by the ECU 9 such that the current source 8 transmits the required power for the release of hydrogen gas. The ECU receives input signals form e.g. a control system and various sensors, such as temperature sensors, pressure sensors, etc. The amount of released hydrogen gas is partly dependent on the temperature in the heat reaction chamber and on the pressure in the energy storage. The temperature in the heat reaction chamber is controlled such that the temperature is held on a desired level and such that the gas flow to the energy storage is in line with the gas absorption in the energy storage.

The electromagnetic field radiated by the first metal coil generates the desired heat that gives the hydrogenated high enthalpy hydride material the desired temperature for hydrogen release at a desired pressure, where the valve 7 is actuated by the ECU 9 to allow the flow of hydrogen gas to the low enthalpy hydride material in the energy storage. By controlling the amount of electromagnetic field generated and transmitted by the first metal coil, the amount of released hydrogen gas from the high enthalpy hydride material and the pressure in the heat reaction chamber is controlled.

The released gas from the heat reaction chamber flows to the energy storage 4 through a valve 7 controlled by the ECU. The valve is opened when the heating of the heat reaction chambers starts or when the pressure in the heat reaction chamber is higher than in the energy storage. Normally, the storage pressure in the energy storage is around 1 bar for a system in an idle state. The energy storage is filled with a low enthalpy hydride material mixed with a susceptor material. Both the low enthalpy hydride material and the susceptor material is a powder or a pressed powder. The low enthalpy hydride material is in the shown example NaAlH₄ but other low enthalpy hydride materials can also be used. In the energy storage, the susceptor material comprises Co, Ni, Fe, SiC or C or a combination thereof. The energy storage comprises a second metal coil 6 that is embedded in the mixture of low enthalpy hydride material and susceptor material. The second metal coil is made of a hollow pipe that is connected to a second fluid circuit 11 through which a heat transfer liquid can be circulated by a second pump 15.

When the released hydrogen gas enters the energy storage, the hydrogen gas is absorbed by the low enthalpy hydride material. The pressure of the gas that is released from the high enthalpy hydride material depends partly of the temperature in the heat reaction chamber, and may be from 5 bars and up to 30-40 bars. In the energy storage, the gas is absorbed by the low enthalpy hydride material. The gas is thus stored as a hydride. The temperature in the energy storage rises when the hydrogen gas is absorbed by the low enthalpy hydride material. The temperature in the energy storage can be controlled by circulating a heat transfer liquid in the second fluid circuit, such that the temperature is held at a desired level.

A temperature-controlled heat transfer liquid may be circulated through the second metal coil to prevent the temperature in the energy storage from rising too much due to the exothermic reaction between the hydrogen gas and the low enthalpy hydride material. The temperature in the energy storage could e.g. be held at a temperature of between 30-80 degrees Celsius, and should preferably be restricted to a maximum of 150 degrees Celsius. By controlling the temperature in the energy storage, the speed of the hydrogen gas absorption in the low enthalpy hydride material can be controlled. As the hydrogen gas absorption continues, the temperature-controlled heat transfer liquid is circulated inside the second metal coil to remove the excess heat from the energy storage and to maintain the desired temperature. By controlling the circulation temperature of the heat transfer liquid circulated through the hollow second metal coil, the absorption time of the hydrogen gas can be controlled.

When the amount of electric energy that is to be stored has been used to heat the heat reaction chamber, or when the high enthalpy hydride material is depleted of hydrogen, the heating process is stopped. The temperature in the heat reaction chamber will slowly decrease, depending on the amount of insulation material used to insulate the heat reaction chamber. In some systems, the energy transfer process is used regularly, e.g. every night. In this case, it is of advantage to hold the temperature in the heat reaction chamber at a constant high temperature. At the same time, the temperature in the energy storage will decrease to a temperature around room or ambient temperature, e.g. around 15-25 degrees Celsius. The temperature in the energy storage may be controlled by circulating the heat transfer liquid through the second metal coil. The pressure in the energy storage will decrease to a low pressure of around 1 bar when all the hydrogen gas is absorbed. It is also possible to include a phase shift material in the low enthalpy material that can absorb the excessive heat produced during the absorption of hydrogen gas into the low enthalpy material.

After a predefined time, or when heating energy is required, the recovery of energy is started. In order to release the hydrogen gas from the low enthalpy hydride material, the energy storage is heated somewhat. Depending on the required energy and thus the gas flow from the energy storage, the low enthalpy hydride material is heated to a temperature above the ambient temperature. A suitable temperature may be between 30-80 degrees Celsius.

The energy storage may be heated by circulating a heated heat transfer liquid through the hollow second metal coil. This type of heating is suitable for lower gas output. It is also possible to heat the energy storage with heat from a phase change material arranged either in the energy storage or close to the energy storage. By releasing the heat from the phase shift material, the low enthalpy material can be heated for hydrogen release back to the high enthalpy material.

To achieve an instant heat release from the high enthalpy hydride material contained in the heat reaction chamber, i.e. to provide a quick hydrogen gas release from the energy storage, an electromagnetic field can be generated and transmitted by the second metal coil inside the energy storage.

In some example embodiments, the alternating current source 8 is connected also to the second metal coil, for example through the switch 13 controlled by the ECU. However, in other example embodiments, the second metal coil 6 may be connected to a separate electrical power source, such as a separate battery powered alternating current source.

The electromagnetic field generated by the second metal coil 6 will heat the susceptor material in the energy storage such that the low enthalpy hydride material is heated and releases the hydrogen gas. The temperature in the energy storage is controlled by precise pulsation of the electromagnetic field to reach the desired temperature needed to release hydrogen at the required rate and pressure needed for the desired energy output. The flow of hydrogen gas and the reaction of hydrogen gas with the high enthalpy hydride material causes an exothermic release of energy, thus delivering heat to a heat exchanger 12 that heats a fluid that can be used e.g. for residential heating.

The heat exchanger 12 is in one example the first coil 5 through which a heat transfer liquid is circulated. It is also possible to provide the heat reaction chamber with other types of fluid tubes that act as a heat exchanger, e.g. a plurality of straight tubes interposed in the high enthalpy hydride material. The tubes may e.g. be arranged between the first coil and the outer side of the heat reaction chamber, and may be used as a heat exchanger together with the first coil in parallel.

In some example embodiments, the heat exchanger 5, 12 may be a part of a Stirling engine that is used for converting thermal energy delivered by the heat storage device 1 to kinematic energy, which for example may be used for driving an electrical generator for providing electrical energy.

In an ideal energy storing device that is empty or fully discharged, the heat reaction chamber will comprise a metal hydride saturated with hydrogen. When the device is fully loaded, the reaction chamber will comprise a metal oxide with no bonded hydrogen, and the energy storage will contain the hydrogen. In an actual device, this is not the case, but a load degree of 70-90% when compared to a theoretical value is possible to obtain, depending e.g. on the selected metal hydride and the used temperatures.

The advantage of using an electromagnetic field to heat the heat reaction chamber is that it is a simple and efficient way to heat the heat reaction chamber in an even and distributed manner, where the complete heat reaction chamber is heated at the same time. With normal resistance heating, the heat transfer in the heat reaction chamber is dependent on the heat conductivity of the high enthalpy hydride material, which is relatively low.

The metal pipe of the first and/or second metal coils 5, 6 may for example be made of stainless steel, copper, titanium, Inconel.

The metal pipe may for example have a diameter of about 25-75 mm, specifically about 35-65 mm. The metal coil 5 may for example have an outer diameter of about 15-60 cm. The heat reaction chamber 3 may for example have a cylindrical form with an interior diameter of about 40-100 cm. The heat storage device according to the disclosure may however have other dimensions and is not limited to the dimensions described above.

In some example embodiments, the first metal coil 5 is located within the heat reaction chamber 3, such that the first metal coil 5 becomes embedded in the mixture of first hydride material and susceptor material when filled. Similarly, the second metal coil 6 is located within the energy storage 4, such that the second metal coil 6 becomes embedded in the mixture of second hydride material and susceptor material when filled.

The first fluid circuit 10 can be connected to a first fluid arrangement 16 having more parts. For example, the first fluid arrangement 16 can include a reservoir or tank for holding an amount of the heat transfer liquid.

The heat transfer liquid may for example be a mixture of water and glycol. The water may preferably be low-conductivity type of water, such as distilled water or deionized water. Alternatively, the heat transfer liquid may an oil-based liquid or a sodium-based liquid, or the like.

The first fluid arrangement 16 can further include liquid heating device and/or a liquid cooling device. A liquid heating device may for example be an electrical heater powered by the renewable electric energy, or the like. Alternatively, the liquid heating device may be a furnace configured to use fossil or renewable fuel as energy source. Still more alternatively, the liquid heating device may be configured to heat the liquid based on waste energy of another process. A liquid cooling device may for example be a dry air cooler that uses ambient forced air cooling, or an industrial cooling tower that uses water cooling, or the like.

The first fluid arrangement 16 can further include a deionizer filter to keep the liquid conductivity at a low level, for avoiding problems with electrolysis, etc.

Operation of the first fluid arrangement 16 and the first pump 14 may be controlled by the ECU 9.

The first fluid circuit 10 can in some example process situations be used for heating of the first hydride material, either in combination with the electromagnetic heating of the first metal coil 5, or separately.

Furthermore, the first fluid circuit 10 can in some other example process situations be used for cooling the first hydride material.

The ECU may receive input information about various process parameters of the heat storage device, for example from one or more sensors. The one or more sensors may for example provide information indicative of the temperature within the heat reaction chamber 3, temperature distribution within the heat reaction chamber 3, temperature of the first metal coil 5, pressure level within the heat reaction chamber 3 and/or the energy storage 4, temperature within the energy storage 4, temperature distribution within the energy storage 4, or temperature and/or flow rate of the heat transfer liquid in the first fluid circuit 10.

The ECU may be configured to control the AC source 8, the first fluid arrangement 18 and/or the first pump 14, and optionally also other parts, such as the valve 7, the switch 13 or the heat exchanger 12, based on information about one or more process parameters of the heat storage device 1 received from sensors or the like. This corresponds to a feedback controller.

In some example embodiments, for example when the energy storage device should be charged with more energy, the ECU 9 may be configured to control each of the AC source 8, the first fluid arrangement 18 and the first pump 14 in combination, while having one or more of the following process inputs as process input variables: temperature profile over time, predetermined temperature, min/max temperature levels, temperature time derivative.

The first fluid circuit 10 can also be used for cooling the pipe of the first metal coil 5 if required.

The second fluid circuit 11 can be connected to a second fluid arrangement 17 having more parts. For example, the second fluid arrangement 17 can include a reservoir or tank for holding an amount of the heat transfer liquid.

The second fluid arrangement 17 can further include liquid heating device and/or a liquid cooling device. A liquid heating device may for example be an electrical heater powered by the renewable electric energy, or the like. Alternatively, the liquid heating device may be a furnace configured to use fossil or renewable fuel as energy source. Still more alternatively, the liquid heating device may be configured to heat the liquid based on waste energy of another process, such as for example waste heat from Stirling engine connected to the thermal energy storage device 1, or heat extracted from the heat reaction chamber 3 by the heat exchanger 12. A liquid cooling device may for example be a dry air cooler that uses ambient forced air cooling, or an industrial cooling tower that uses water cooling, or the like.

Operation of the second fluid arrangement 17 and the second pump 14 may be controlled by the ECU 9.

The second fluid circuit 11 can in some example process situations be used for heating of the second hydride material, either in combination with the electromagnetic heating of the second metal coil 5, or separately.

Furthermore, the second fluid circuit 11 can in some other example process situations be used for cooling the second hydride material.

The ECU may also be configured to control operation of the first fluid arrangement 16 and the first pump 14, as well as the second fluid arrangement 17 and second pump 15.

The first and second fluid circuits 10, 11 may be two separate fluid circuits with separate fluid pumps 14, 15 and separate fluid arrangements 15, 16. Alternatively, the first and second fluid circuits 10, 11 may be integrated into a single common fluid circuit, wherein the flow and temperature of each of the first and second fluid circuits 10, 11 is individually controllable.

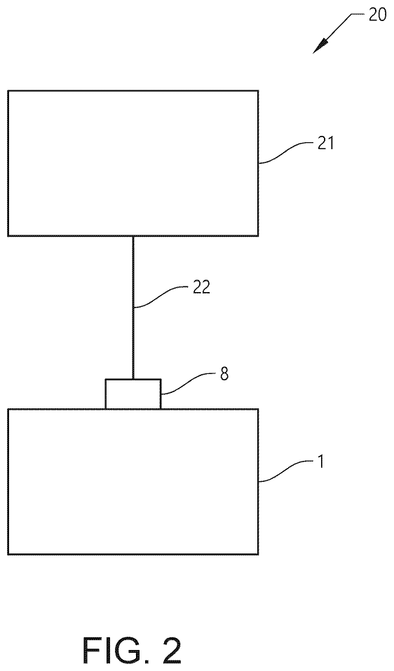

In a system 20 for storing renewable electric energy, shown in FIG. 2, a renewable electric energy source 21 and an energy storage device 1 are comprised. The renewable electric energy source may be either a photovoltaic power plant that produces electric energy when the sun is shining or a wind power plant that produces electric energy when the wind is blowing. The electric energy is transferred from the renewable electric energy source to the electromagnetic source 8 of the energy storage device through an inlet power cable 22.

The invention is not to be regarded as being limited to the embodiments described above, a number of additional variants and modifications being possible within the scope of the subsequent patent claims. The thermal storage device may e.g. have any size and shape.

### REFERENCE SIGNS

1: Electric energy storage device
3: Heat reaction chamber
4: Energy storage
5: First metal coil
6: Second metal coil
7: Valve
8: Electromagnetic source
9: Electronic control unit
10: First fluid circuit
11: Second fluid circuit
12: Heat exchanger
13: Switch
14: First pump
15: Second pump
16: First fluid arrangement
17: Second fluid arrangement
20: System
21: Renewable power plant
22: Inlet cable

1. A device for storing electric energy, comprising a heat reaction chamber, an energy storage, and a heat exchanger (12) adapted to be heated by the heat reaction chamber, where the heat reaction chamber comprises a first hydride material mixed with a susceptor material and a first metal coil, where the energy storage comprises a second hydride material mixed with a susceptor material and a second metal coil, and where a valve is arranged between the heat reaction chamber and the energy storage, wherein the device comprises an alternating current source connected to the first metal coil and adapted to output an alternating current to the first metal coil, where the first metal coil acting as an antenna is adapted to generate and transmit an electromagnetic field to the susceptor material in the heat reaction chamber, such that the first hydride material can be heated to release a hydrogen gas.

2. The Device according to claim 1, wherein the heat reaction chamber is adapted to hold a temperature between 750 to 900 degrees Celsius when the heat reaction chamber is heated by the electromagnetic field.

3. The Device according to claim 2, wherein the heat reaction chamber is adapted to hold the temperature between 800 to 900 degrees Celsius when the heat reaction chamber is heated by the electromagnetic field.

4. The Device according to claim 1, wherein the first hydride material comprises a metal selected from the group: sodium (Na), magnesium (Mg), titanium (Ti), calcium (Ca), aluminium (Al), iron (Fe), strontium (Sr) or barium (Ba).

5. The Device according to claim 1, wherein the susceptor material in the heat reaction chamber (3) comprises Co, Ni, Fe, SiC or C or a combination thereof.

6. The Device according to claim 1, wherein the second hydride material is NaAlH4.

7. The Device according to claim 1, wherein the susceptor material in the energy storage comprises Co, Ni, Fe, SiC or C or a combination thereof.

8. The Device according to claim 1, wherein the second metal coil is connectable to the alternating current source or to a separate alternating current source.

9. The Device according to claim 8, wherein the first metal coil and/or the second metal coil is hollow and adapted to convey a heat transfer fluid.

10. The Device according to claim 1, wherein the energy storage comprises a phase change material.

11. The Device according to claim 1, wherein the first hydride material is a high enthalpy hydride material and the second hydride material is a low enthalpy hydride material.

12. The Device according to claim 1, wherein the second metal coil is connected to the alternating current source or to a separate electrical power source, wherein said alternating current source or separate electrical power source is adapted to output an alternating current to the second metal coil, where the second metal coil is adapted to generate and transmit an electromagnetic field to the susceptor material in the energy storage, such that the second hydride material can be heated.

13. A system for storing renewable electric energy, comprising an electric energy storage device according to claim 1, and a renewable energy source.

14. The system according to claim 13, wherein the renewable electric energy source (21) is a photovoltaic power plant or a wind power plant.

15. A method for storing electric energy, comprising the steps of:
producing electric energy with a renewable electric energy source,
heating a heat reaction chamber of an energy storage device comprising a first hydride material and a susceptor material with an electromagnetic field generated and transmitted by a first metal coil embedded in the heat reaction chamber with the electric energy, such that a hydrogen gas is released from the first hydride material,
transferring the released hydrogen gas from the heat reaction chamber to an energy storage through a valve, wherein the energy storage comprises a second hydride material mixed with a susceptor material and a second metal coil,
storing the released hydrogen gas in the energy storage for a time interval,
releasing the stored gas from the energy storage,
returning the released gas from the energy storage to the heat reaction chamber through a valve by controlled heating of the energy storage,
converting the stored gas to heat in the heat reaction chamber by hydrogen gas reaction with the first hydride material,
heating a heat exchanger with heat from the heat reaction chamber, where the heat exchanger is connected to an external system.

16. The method according to claim 15, wherein the energy storage is heated by an electromagnetic field when the hydrogen gas is to be released from the energy storage.

17. The method according to claim 15, wherein the energy storage is heated by a phase change material arranged in the energy storage when the hydrogen gas is to be released from the energy storage.
